(19) United States
(12) Patent Application Publication
(10) Pub. No.: US 2002/0071907 A1
(43) Pub. Date: Jun. 13, 2002

(54) Method for the manufacture of a composite of continuous fibres and plastic

(75) Inventors: Albert M. Vodermayer, Dietlikon (CH); Jens C. Kaerger, Winterthur (CH); Wolfram F.W. Auersch, Wiesendangen (CH); Markus Hofmeier, Winterthur (CH); Costantino Bellusci, Winterthur (CH); Christoph Mayer, Winterthur (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sulzer Markets and Technology AG, Winterthur (CH)

(21) Appl. No.: 10/003,835

(22) Filed: Dec. 3, 2001

(30) Foreign Application Priority Data
Dec. 13, 2000 (EP) 00811183.3

(51) Int. Cl. B05D 3/02; B05D 1/02

(52) U.S. Cl. 427/195; 427/421; 427/385.5; 118/308

(57) ABSTRACT

The invention relates to a method for the manufacture of a composite of continuous fibers (11) and plastic. The fibers are present as a unidirectional fiber arrangement (1) or in the form of strand-like, multi-fibrous threads (1), with these threads forming a textile thread arrangement (10), in particular a fabric or braided fabric. The fibers are embedded into a plastic matrix, wherein a polymer or different polymers are provided for the manufacture of the matrix. The fiber arrangement or thread arrangement (1, 10) is draw off from a supply point, in particular a supply reel (100), and impregnated with particles of plastic, with subsequently at least a part of the particles being converted by melting into the matrix. A mean diameter of the particles is not substantially larger than the diameter of the fibers (11). The fiber arrangement or thread arrangement (1, 10) is transported without deflecting elements and guided in one plane. The particles are sprayed onto the fiber arrangement or thread arrangement suspended in a liquid and the liquid of the sprayed suspension (30) is removed by means of evaporation in a drying step (51) prior to conversion melting (52).

The invention relates to a method for the manufacture of a composite of continuous fibres and plastic in accordance with the preamble of claim 1 and to an apparatus to carry out the method.

The manufacture of unidirectionally fibre-reinforced thermoplastics is known from EP-A 0 937 560 which is carried out with pressure impregnation of a fibre strand while using a dispersion of plastic particles. The strand is drawn through a bath holding the dispersion and thereby multiply guided around cylindrical deflecting rolls. Particles from the dispersion are pressed between the fibres and held fast there in a wedge-shaped region between the strand and the surface of the partly wrapped-around deflecting roll due to the movement of the strand. The quantity taken up depends in a complex manner on different parameters: on the concentration of the particles in the bath; the rate at which the strand is drawn through the bath; the number of deflecting rolls; the wrapping angle. A method is disclosed which is carried out at a particular operating point (specific selection of the parameters) and which allows a constant quantity of plastic particles to be applied to the fibre strand without any regulation. A corresponding method—which, however, requires regulation—is known from DE-A 41 21 915. The disadvantage of the impregnation method without regulation is that complex pre-trials have to be carried out for the setting of the particular operating point in order to find the values for the said parameters.

In order to obtain a good quality of the composite, a mean diameter of the plastic particles must be smaller than a maximum diameter which is approximately as large as the diameter of the fibres or also somewhat larger. A mean diameter is defined with respect to a size distribution, for example as a “median 50 value”. A distribution with respect to the volume can be determined by a particle size analysis using a sedimentation cell. If the fibres have different diameters, plastic particles are advantageously used whose mean diameter is smaller than the finest fibre diameter.

Fabric or other textile arrangements of such fibre strands, for example braided fabric, can be subjected to pressure impregnation in place of fibre strands. Depending on the fabric, an unfavourable effect of the deflecting rolls can result in irregular displacements occurring between the threads, i.e. the fibre strands, in the textile arrangements. These displacements result in unusable products. Moreover, the threads of the fabric can be impregnated even less adequately with constant quantities of plastic particles than is the case with the non-woven fibre strands.

It is the object of the invention to provide a method for the manufacture of a composite in which the said disadvantages in connection with impregnation do not occur. This object is satisfied by the method defined in claim 1.

The method relates to the manufacture of a composite of continuous fibres and plastic. The fibres are present as a unidirectional fibre arrangement or in the form of strand-like, multi-fibrous threads, with these threads forming a textile thread arrangement, in particular a fabric or braided fabric. The fibres are embedded into a plastic matrix and a polymer or different polymers are provided for the manufacture thereof. The fibre arrangement or thread arrangement is drawn off from a supply point, in particular from a supply reel, and impregnated with particles of plastic, with subsequently at least a part of the particles being converted by melting into the matrix. A mean diameter of the particles is not substantially larger than the diameter of the fibres. The fibre arrangement or thread arrangement is transported without deflecting elements and guided in one plane. The particles are sprayed onto the fibre arrangement or thread arrangement while suspended in a liquid and the liquid of the sprayed suspension is removed by evaporation in a drying step prior to conversion melting.

The dependent claims 2 to 8 relate to advantageous embodiments of the method in accordance with the invention. claims 9 and 10 relate to an apparatus for the carrying out of the method in accordance with the invention.

The invention is explained below with reference to the drawings in which are shown:

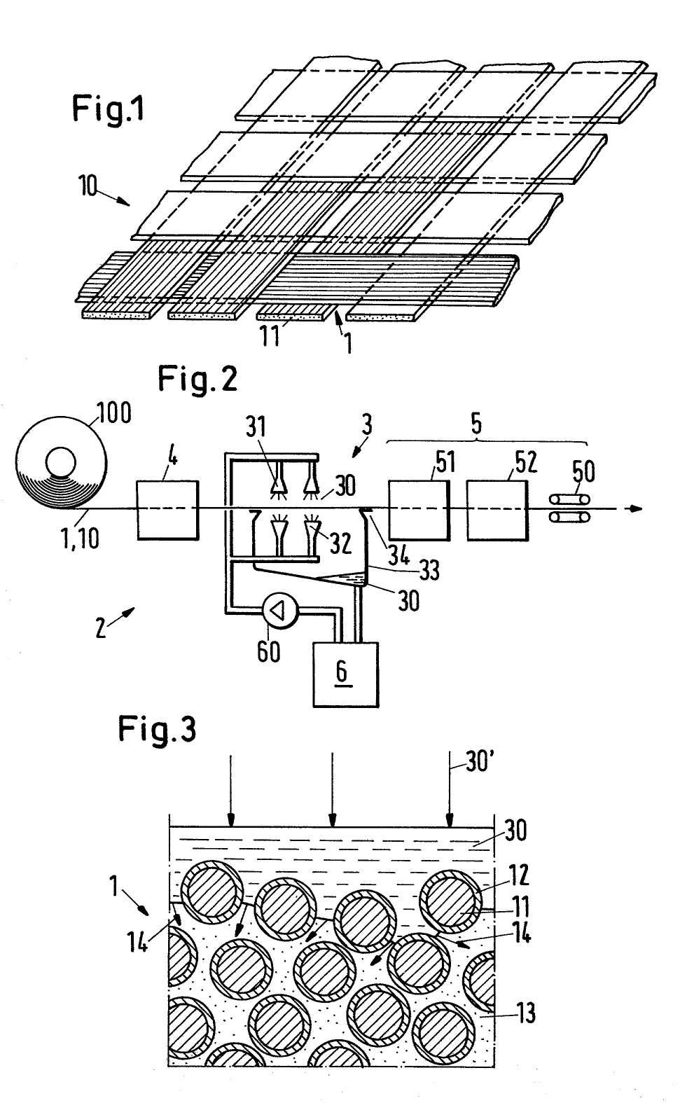

FIG. 1 a fabric with threads which are fibre strands;

FIG. 2 a schematic representation of an apparatus with which the method in accordance with the invention can be carried out; and

FIG. 3 a section-wise cross-section of a fibre strand.

The fabric 10 shown in FIG. 1 consists of threads 1 which are strands of unidirectionally arranged continuous threads 11. This fabric 10, a different textile thread arrangement or an unwoven fibre arrangement 1 can be treated in an apparatus 2 of FIG. 2 in accordance with the method in accordance with the invention.

The fibre arrangement or thread arrangement 1, 10 is drawn off from a supply reel 100 (or supply point) and treated in the apparatus 2 while using diverse process steps. The transportation, in which the fibre arrangement or thread arrangement 1, 10 is guided in one plane, takes place without deflecting elements so that no irregular displacements of the threads result during the treatment of a textile arrangement.

The impregnation is no longer carried out in a bath, but in a spray device 3 by means of nozzles 31, 32, with which a suspension 30 containing the plastic particles is sprayed onto the fibre arrangement or thread arrangement 1, 10. The fibre arrangement or thread arrangement 1, 10 is transported horizontally in the example shown, with the suspension 30 being sprayed from the top by nozzles 31 and from the bottom by nozzles 32. It is also possible, but less advantageous, to spray only from the top or only from the bottom. Suspension 30, which is not picked up or held by the fibre arrangement or thread arrangement 1, 10, is collected in a tank 33 and fed into a reservoir 6 from there. A pump 60 continuously transports suspension 30 from this reservoir 6 into the nozzles 31 and 32. The upper rims 34 of the tank 33 can be formed as guide members for the fibre arrangement or thread arrangement 1, 10. The treatment is continued subsequent to the spraying on in a part device 5 using known process steps. The liquid of the sprayed suspension—as a rule water—is removed by evaporation in a drying step carried out in a first stove 51, a tunnel stove. At least a part of the plastic particles taken up is converted my melting into the matrix of the composite to be manufactured in a second stove 52. The fibre arrangement or thread arrangement 1, 10 is drawn through the apparatus 2 by means of a transportation device 50.

In this method in accordance with the invention and in contrast to the previously known methods, it can be accurately determined how much plastic is applied when the quantity of suspension 30 sprayed and held on the fibre arrangement or thread arrangement 1, 10 is measured. Therefore no regulation is provided and no special operating state has to be observed either.

The fibre arrangement or thread arrangement 1, 10 is advantageously heated in a tunnel stove 4 prior to the spraying on of the suspension 30. The capability of the thread arrangement 1 to accept the suspension 30 is improved in this process step. A first reason for this improvement is the fact that—see FIG. 3—the air located in spaces 13 of the thread arrangement 1 is cooled during spraying on (arrows 30′), with the air pressure reducing there, which effects a suction (arrows 14) of the suspension 30 into the spaces 13. For this effect to actually take place, the fibre arrangement or thread arrangement 1, 10 must be sprayed from both sides.

There can be a second reason for the improvement in the receiving capability which is even more effective when favourable circumstances prevail. This reason consists, for example, of the fact that water is adsorbed on or in the fibres 11 of the fibre arrangement or thread arrangement 1, 10. The water is desorbed during the heating in the stove 4 and thereby displaces—see FIG. 3—air from the spaces 13 of the fibre arrangement 1. During the spraying on 30′ of the suspension 30 and the cooling associated therewith, the desorbed water condenses again which results in a suction of the suspension 30 into the spaces 13.

Adsorbed water can be contained in a size 12 with which the fibres 11 are coated. Fibres coated with sizes 12 are often used to improve the wettability with the plastic melt during the forming of the matrix. The fibres 11 are heated by means of the stove 4 during heating to a temperature at which the size 12 remains intact or largely intact. (Depending on the size, heating can be up to 120° C. or also higher, up to 300° C.). As a rule, hydrophilic components are contained in the sizes 12, thanks to which water is also actually contained in the fibres 11. The coating formed with the size 12 is usually not so wettable for water so that the dispersion 30 sprayed on does not penetrate the fibre arrangement 1 due to capillary forces alone.

The fibres 11 of the fibre arrangement or thread arrangement 1, 10 can be in a state during the drawing off from the supply point in which the substance which is used as the liquid for the suspension is present in adsorbed form. The fibres can naturally also only be brought into such a state by wetting after the drawing off from the supply point 100, with also a relatively high amount of the liquid being applied to the fibre arrangement or thread arrangement 1, 10 so that the fibres 1 carry liquid films on their surfaces.

Powder-like thermoplasts are used as polymers for the plastic matrix. These can have powders of thermosetting plastics and/or anorganic materials added to them in small quantities.

The process steps of heating, spraying on and drying can be repeated after the drying step in the stove 51 in order to increase the quantity of plastic taken up. This can also be repeated manifold times before the method is completed with the melting of the plastic in the stove 52.

1. A method for the manufacture of a composite of continuous fibres (11) and plastic, with the fibres being present as a unidirectional fibre arrangement (1) or in the form of strand-like, multi-fibrous threads (1) and these threads forming a textile thread arrangement (10), in particular a fabric or braided fabric, and with the fibres being embedded into a plastic matrix, wherein a polymer or different polymers are provided for the manufacture of the matrix, in which method the fibre arrangement or thread arrangement (1, 10) is drawn off from a supply point, in particular a supply reel (100), and impregnated with particles of plastic and subsequently at least a part of the particles is converted by melting into the matrix, characterised in that the fibre arrangement or thread arrangement (1, 10) is transported without deflecting elements and guided in one plane; in that the particles are sprayed onto the fibre arrangement or thread arrangement suspended in a liquid; and in that the liquid of the sprayed suspension (30) is removed by means of evaporation in a drying step (51) prior to the conversion melting (52).

2. A method in accordance with claim 1, characterised in that the fibre arrangement or thread arrangement (1, 10) is heated in a tunnel stove directly prior to the spraying on of the suspension.

3. A method in accordance with claim 1 or claim 2, characterised in that the threads (11) have a surface which is substantially more wettable for the melted plastic particles than for the liquid of the suspension (30) and in that the liquid of the suspension is in particular water.

4. A method in accordance with any one of the claims 1 to 3, characterised in that the fibre arrangement or thread arrangement (1, 10) is transported horizontally and in that the suspension (30) is sprayed onto the fibre arrangement or thread arrangement from the top and/or bottom, preferably from the top and bottom.

5. A method in accordance with any one of the claims 1 to 4, characterised in that powder-like thermoplastics are used as polymers for the plastic matrix and that powders of thermosetting plastics and/or anorganic materials can be added thereto in small quantities.

6. A method in accordance with any one of the claims 2 to 5 and in accordance with claim 2, characterised in that the fibres (11) of the fibre arrangement or thread arrangement (1, 10) are in a state or are brought into such a state during the drawing off from the supply point in which the fibres carry the substance, which is used as the liquid for the suspension (30), in adsorbed form or as a surface film.

7. A method in accordance with any one of the claims 2 to 6 and in accordance with claim 2, characterised in that the process steps of heating by means of a tunnel stove (4), subsequent spraying (3) with suspension (30) and drying (51) are repeated after the drying step (51) or a further drying step (51).

8. A method in accordance with any one of the claims 2 to 7 and in accordance with claim 2, characterised in that the fibres (11) are coated with a size (12) and in that the fibres are heated to a temperature during heating by means of a tunnel stove (4) at which the size remains intact or largely intact.

9. An apparatus (2) for the carrying out of the method in accordance with any one of claims 1 to 8, comprising the following components: a supply reel (100) with a fibre arrangement or thread arrangement (1, 10); a spray device (3) with nozzles (31, 32); guide elements (34) to guide the fibre arrangement or thread arrangement in one plane; a drying stove (51), a conversion melting stove (52) and a transportation device (50).

10. An apparatus in accordance with claim 9, characterised by a tunnel stove (4) between the supply reel (100) and the spray device (3) for a heating of the fibre arrangement or thread arrangement (1, 10).
